(19) United States
(12) Patent Application Publication
(10) Pub. No.: US 2025/0273787 A1
(43) Pub. Date: Aug. 28, 2025

(54) BATTERY PACK

(71) Applicant: TOYOTA JIDOSHA KABUSHIKI KAISHA, Aichi-ken (JP)

(72) Inventors: Masaki MIWA, Nagakute-shi, Aichi-ken (JP); Keita ITO, Aichi-gun, Aichi-ken (JP); Tsuyoshi HAYASHI, Miyoshi-shi, Aichi-ken (JP); Toshiharu SHINYA, Toyota-shi, Aichi-ken (JP); Shota HIRASHIMA, Toyota-shi, Aichi-ken (JP)

(21) Appl. No.: 19/062,012

(22) Filed: Feb. 25, 2025

(30) Foreign Application Priority Data
Feb. 28, 2024 (JP) 2024-028804

(51) Int. Cl. H01M 50/204; H01M 10/613; H01M 10/6563; H01M 50/583

(52) U.S. Cl. CPC H01M 50/204; H01M 10/613; H01M 10/6563; H01M 50/583; H01M 2200/103; H01M 2220/20

(57) ABSTRACT

The battery pack comprises a plurality of cell modules; and at least one battery-related device, wherein the plurality of cell modules are arranged side by side in a longitudinal direction thereof, with an intermediate space interposed therebetween, and the at least one battery-related device is disposed inside the intermediate space or above the intermediate space.

### CROSS REFERENCE TO RELATED APPLICATION

This application claims priority to Japanese Patent Application No. 2024-028804filed on Feb. 28, 2024, which is incorporated herein by reference in its entirety including the specification, claims, drawings, and abstract.

### TECHNICAL FIELD

This specification discloses a battery pack mounted on a vehicle.

### BACKGROUND

A battery pack for charging and discharging electric power is mounted on an electric vehicle using a motor as a power source. The battery pack typically includes a plurality of cell modules and one or more battery-related devices. The cell module is a component in which a plurality of battery cells are formed into one component. The battery-related device is, for example, an ECU, a connector, a duct, or the like.

Patent Document 1 discloses a battery pack in which a plurality of cell modules are arranged in the vehicle longitudinal direction. In the Patent Document 1, the cell module has a substantially rectangular parallelepiped shape elongated in the vehicle width direction. In the Patent Document 1, the battery-related device is disposed adjacent to the cell module in the vehicle width direction.

Here, in order to reduce the dimension of the battery pack in the short direction, a plurality of cell modules may be arranged in the longitudinal direction of the cell modules. In this case, there is a problem that the longitudinal dimension of the battery pack becomes excessively large depending on the arrangement of the battery-related devices.

Accordingly, the present specification discloses a battery pack in which the arrangement efficiency of parts is improved.

### CITATION LIST

PATENT DOCUMENT 1: JP.2008-234870.A

### SUMMARY

A battery pack disclosed in the present specification comprises: a plurality of cell modules; and at least one battery-related device, wherein the plurality of cell modules are arranged side by side in a longitudinal direction thereof, with an intermediate space interposed therebetween, and the at least one battery-related device is disposed inside the intermediate space or above the intermediate space.

In this case, the at least one battery-related device may include: an electronic device disposed above the intermediate space; and a connector that is disposed below the electronic device and electrically relays the electronic device and a wire harness, and a dimension of the intermediate space in the longitudinal direction may be smaller than a dimension of the electronic device in the longitudinal direction.

The at least one battery-related device may include: a fuse disposed inside the intermediate space; and a connector which is disposed inside the intermediate space or above the intermediate space and to which a wire harness extending from each of the plurality of cell modules may be connected.

Further, the connector may be disposed in an orientation such that an insertion opening of the wire harness faces downward.

The at least one battery-related device may include a duct, a part of which is disposed inside the intermediate space.

According to the technology disclosed in the present specification, the arrangement efficiency of parts is improved.

### BRIEF DESCRIPTION OF DRAWINGS

Embodiment(s) of the present disclosure will be described based on the following figures, wherein:

FIG. 1 is a perspective view of a battery pack;

FIG. 2 is a schematic view showing an arrangement of battery packs;

FIG. 3 is a schematic diagram showing a battery controller and an arrangement of the battery controller;

FIG. 4 is a schematic diagram showing the arrangement of fuses;

FIG. 5 is a schematic view showing an arrangement of ducts; and

FIG. 6 is a diagram showing an example of another battery pack.

### DESCRIPTION OF EMBODIMENT

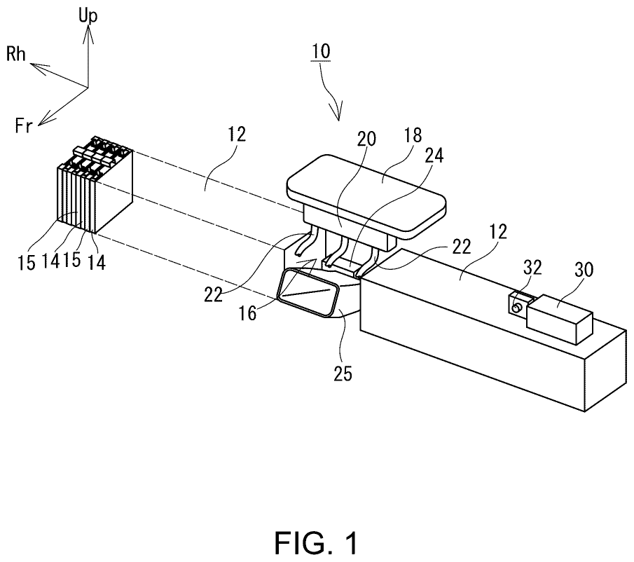

Hereinafter, a configuration of the battery pack 10 will be described with reference to the drawings. FIG. 1 is a schematic perspective view of a battery pack 10. In the drawings, Fr, Up, and Rh indicate the front side, the upper side, and the right side of the vehicle, respectively.

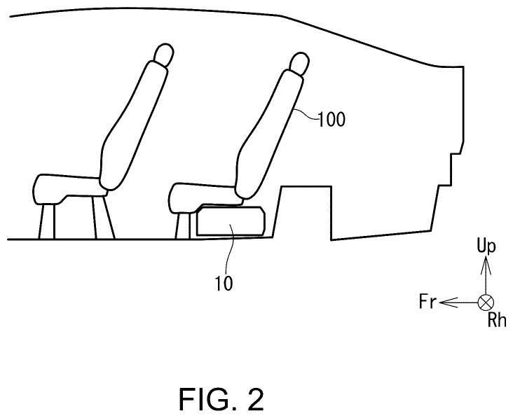

The battery pack 10 shown in FIG. 1 is mounted on an electric vehicle and supplies electric power to a traveling motor. The electric vehicle is a vehicle having a motor as one of power sources, and corresponds to, for example, a hybrid electric vehicle, a battery electric vehicle, a fuel cell electric vehicle, and the like. The battery pack 10 is disposed in a place that is not in the way of an occupant, for example, below a luggage space or an in-vehicle seat. In this example, the battery pack 10 is disposed below the rear seat 100, as shown in FIG. 2. In addition, in the present example, the battery pack 10 is disposed in a posture in which the longitudinal direction of a cell module 12, which will be described later, is parallel to the vehicle width direction. Therefore, the arrow Rh indicating the right side in FIGS. 1 to 6 is the same direction as the longitudinal direction of the cell module 12, and the arrow Fr indicating the front side is the same direction as the short direction of the cell module 12.

The battery pack 10 is configured by housing a plurality of cell modules 12 and one or more battery-related devices in one case (not shown). The cell module 12 is configured by alternately stacking a plurality of battery cells 14 and a plurality of separators 15 in the thickness direction. The battery cell 14 is a secondary battery that can be charged and discharged. For example, the battery cell 14 is a lithium ion secondary battery or a sodium ion secondary battery. The battery cell 14 may be an all-solid-state battery. The battery cell 14 is a rectangular battery having a flat rectangular parallelepiped shape. The plurality of battery cells 14 are electrically connected in series or in parallel by conductors called bus bars. The separator 15 is a plate made of an insulating material. Grooves that function as flow paths through which the cooling fluid flows are formed on the surface of the separator 15.

The cell module 12 in which the plurality of battery cells 14 and the plurality of separators 15 are stacked has a substantially rectangular parallelepiped shape elongated in the stacking direction. The battery pack 10 includes two cell modules 12. In the present example, the two cell modules 12 are arranged side by side in the longitudinal direction of the cell module 12. The reason for this arrangement is to improve space efficiency, which will be described later. The battery pack 10 is disposed such that the longitudinal direction of the cell module 12 is substantially parallel to the vehicle width direction. Therefore, in the present example, the longitudinal direction of the cell module 12 is substantially parallel to the vehicle width direction, and the short direction of the cell module 12 is substantially parallel to the vehicle longitudinal direction.

An intermediate space 16 is provided between two adjacent cell modules 12. The size of the intermediate space 16 is not particularly limited. However, if the intermediate space 16 is excessively large, the dimension of the battery pack 10 in the longitudinal direction becomes large. On the other hand, if the intermediate space 16 is excessively small, the battery-related device to be described later may not be disposed, or the workability of the connection work of the wire harness 22 may be deteriorated. Therefore, the intermediate space 16 may have, for example, a size that allows the hand of the operator to enter. Therefore, the intermediate space 16 may be set in a range of 5 cm or more and less than 20 cm, for example.

The battery pack 10 further includes one or more battery-related devices. The battery-related device is a device necessary for safely driving the battery pack 10. For example, the battery controller 18, the connector 20, the fuse 24, the duct 25, the junction box 30, and the service plug 32 correspond to the battery-related device. The battery controller 18 is a computer that controls charging and discharging of the cell module 12, and is generally an electronic device called an ECU (Electronic Control Unit). The battery controller 18 has a flat rectangular shape and is disposed above the intermediate space 16.

A wire harness 22 drawn from the cell module 12 is electrically connected to the connector 20. For example, the connector 20 is a female connector into which a male connector attached to the end of the wire harness 22 is inserted. The connector 20 is also electrically connected to the battery controller 18. The connector 20 relays power or electrical signals between the battery controller 18 and the cell module 12. As shown in FIG. 1, the connector 20 is disposed below the battery controller 18 in a posture in which the insertion port of the wire harness 22 faces downward.

The fuse 24 is an electronic component that protects the cell module 12 from overcurrent. As shown in FIG. 1, the fuse 24 is disposed inside the intermediate space 16. The duct 25 is a flow path that allows the cell module 12 to communicate with a cooling flow path and a blower (not shown). As shown in FIG. 1, at least a part of the duct 25 is disposed inside the intermediate space 16. The duct 25 and the fuse 24 are arranged in the short direction of the cell module 12 in the intermediate space 16.

The junction box 30 is an electronic component in which relays for allowing or blocking the flow of electric power are unitized. The junction box 30 is disposed above the cell module 12. The service plug 32 is a component provided at an intermediate point of the power supply circuit, and is a component that cuts off a high voltage by being removed. When servicing the battery pack 10, the operator removes the service plug 32 in advance. After the maintenance is completed, the operator reattaches the service plug 32. In this example, the service plug 32 is disposed above the cell module 12 and next to the junction box 30.

As is clear from the above description, in the present example, the two cell modules 12 are arranged side by side in the longitudinal direction of the cell modules 12. The reason for this configuration will be described. As described above, in the present embodiment, the battery pack 10 is disposed below the rear seat 100. The dimension in the front-rear direction of the lower side of the rear seat 100 is smaller than the dimension in the vehicle width direction. Therefore, the size of the battery pack 10 disposed on the lower side of the rear seat 100 in the front-rear direction is required to be as small as possible.

Therefore, in this example, the two cell modules 12 are arranged in the longitudinal direction, and the battery pack 10 is disposed below the rear seat 100 in a posture in which the longitudinal direction is substantially parallel to the vehicle width direction. With this arrangement, the dimension of the battery pack 10 in the vehicle front-rear direction can be suppressed to be small.

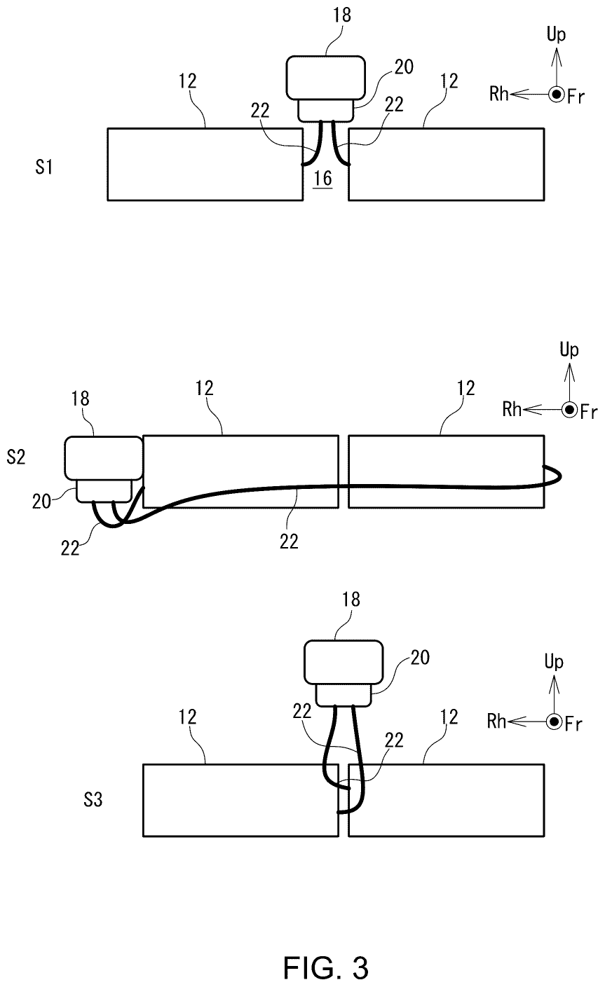

Further, in the present embodiment, the intermediate space 16 is provided between the two cell modules 12, and the battery-related device is provided inside or above the intermediate space 16. The reason for this arrangement will be described with reference to FIGS. 3 to 5. FIG. 3 is a schematic front view of the battery pack 10. The state S1 in the upper part of FIG. 3 shows the arrangement of the present example, and the state S2 in the middle part of FIG. 3 and the state S3 in the lower part of FIG. 3 show the arrangement of the comparative example, respectively.

First, as in the state S2, a case where the two cell modules 12 are arranged without a gap and the battery controller 18 and the connector 20 are disposed outside in the longitudinal direction is considered. In this case, the dimension of the battery pack 10 in the longitudinal direction is increased by the width of the battery controller 18. Further, in the case of the state S2, since the distance from the cell module 12 on the right side of the drawing to the connector 20 becomes long, the wire harness 22 becomes long. Further, in the case of the state S2, the battery controller 18 and the connector 20 are disposed within the range in the height direction of the cell module 12. In this case, it is difficult to secure a sufficient work space below the connector 20. As a result, the workability of the connection of the wire harness 22 is poor. If the insertion opening of the connector 20 is directed upward, the workability is improved, but in this case, another problem is caused in that foreign matter easily adheres to the insertion opening.

Therefore, as shown in the state S3, two cell modules 12 may be disposed without a gap therebetween, and the battery controller 18 and the connector 20 may be provided above the cell modules 12. With this arrangement, the dimension of the battery pack 10 in the longitudinal direction can be reduced. However, in this case, in order to secure a work space for connecting the wire harness 22 to the connector 20, it is necessary to dispose the battery controller 18 and the connector 20 so as to be largely separated from the cell module 12. As a result, in the state S3, the dimension of the battery pack 10 in the height direction becomes significantly large, and it becomes difficult to dispose the battery pack 10 below the rear seat 100.

On the other hand, in this example, as shown in the state S1, the intermediate space 16 is provided between the two cell modules 12. The battery controller 18 and the connector 20 are disposed above the intermediate space 16. In this case, the dimension of the battery pack 10 in the longitudinal direction can be made smaller than that in the state S2. In addition, the wire length of the wire harness 22 can be significantly reduced. Further, in this case, the intermediate space 16 can be used as a work space for connection of the wire harness 22. As a result, in the state S1, the battery controller 18 and the wire harness 22 can be disposed near the cell module 12. Accordingly, the size of the battery pack 10 in the height direction can be suppressed to be small.

In this example, in order to sufficiently reduce the dimension of the entire battery pack 10 in the longitudinal direction, the dimension of the intermediate space 16 in the longitudinal direction is made smaller than either the dimension of the battery controller 18 in the longitudinal direction or the dimension of the connector 20 in the longitudinal direction. However, when the installation space of the battery pack 10 is sufficiently wide, the dimension of the intermediate space 16 in the longitudinal direction may be larger than the dimension of the battery controller 18 in the longitudinal direction or the dimension of the connector 20 in the longitudinal direction. Both the battery controller 18 and the connector 20 or only the connector 20 may be disposed inside the intermediate space 16. With this configuration, the size of the battery pack 10 in the height direction can be suppressed to be small. In addition, the connector 20 may be disposed in a posture in which the insertion port faces upward as long as a sufficient dustproof measure can be taken.

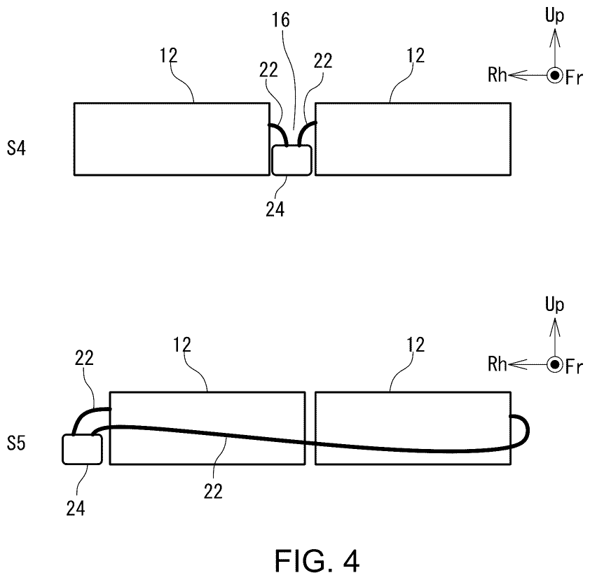

Next, the arrangement of the fuses 24 will be described with reference to FIG. 4. FIG. 4 is a schematic front view of the battery pack 10. A state S4, which is the upper stage of FIG. 4, shows the arrangement of the present example, and a state S5, which is the lower stage of FIG. 4, shows the arrangement of the comparative example. When the two cell modules 12 are disposed without a gap and the fuse 24 is disposed outside in the longitudinal direction as in the state S5, the dimension of the battery pack 10 in the longitudinal direction becomes large, and the wire length of the wire harness 22 also becomes long. When the fuse 24 is disposed above the cell module 12, the height of the battery pack 10 increases.

On the other hand, in this example, as shown in the state S4, the fuse 24 is disposed inside the intermediate space 16. As a result, the wire length of the wire harness 22 is reduced. In this example, the dimension of the fuse 24 in the longitudinal direction is smaller than either the dimension of the connector 20 in the longitudinal direction or the dimension of the intermediate space 16 in the longitudinal direction. However, the arrangement and size of the fuses 24 are merely examples, and the fuses 24 may be disposed outside the intermediate space 16. For example, the fuse 24 may be disposed on the intermediate space 16 or on the cell module 12.

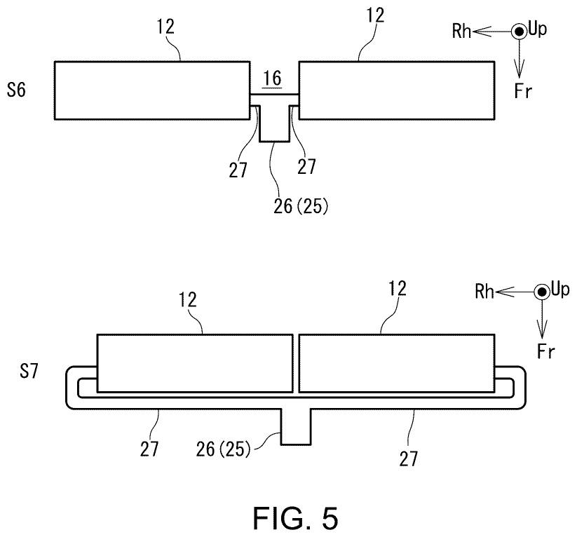

Next, the arrangement of the duct 25 will be described with reference to FIG. 5. FIG. 5 is a schematic top view of the battery pack 10. In FIG. 5, a state S6 in the upper stage shows the arrangement of the present example, and a state S7 in the lower stage shows the arrangement of the comparative example. As shown in FIG. 5, the duct 25 is roughly divided into a sub duct 27 connected to each of the cell modules 12, and a main duct 26 in which a plurality of sub ducts 27 merge.

When the two cell modules 12 are disposed without a gap as in the state S7, the main duct 26 needs to be disposed on the front side or the rear side of the cell modules 12. For example, a case where the main duct 26 is disposed on the front side of the two cell modules 12 is considered. In this case, the sub duct 27 connecting the main duct 26 and the cell module 12 is connected to the main duct 26 through the front side of the cell module 12 from the outside in the longitudinal direction of the cell module 12. As a result, in this case, the path of the sub duct 27 becomes long, and a large curve is generated in the middle of the path of the sub duct 27. As a result, the pressure loss increases, and thus the cooling efficiency of the cell module 12 decreases. In addition, in the case of the state S7, since a space for arranging the sub duct 27 is necessary, the dimension of the battery pack 10 in the short direction increases accordingly.

On the other hand, in this example, as in the state S6, the intermediate space 16 is provided between the two cell modules 12, and a part of the main duct 26 is disposed inside the intermediate space 16. In this case, the sub duct 27 extends linearly from the longitudinally inner end of the cell module 12 toward the main duct 26. As is clear from FIG. 5, in the case of the state S6, the sub duct 27 is significantly shorter than in the case of the state S7, and the curve of the sub duct 27 is small. As a result, in the state S6, since the pressure loss can be reduced, the cooling efficiency of the cell module 12 is improved. Further, in the case of the state S6, since the sub duct 27 can be disposed within the range in the lateral direction of the cell module 12, the dimension of the battery pack 10 in the lateral direction is reduced.

The arrangement of the duct 25 is also an example, and the duct 25 may be arranged outside the intermediate space 16. For example, the duct 25 may be disposed outside in the longitudinal direction or outside in the lateral direction of the two cell modules 12.

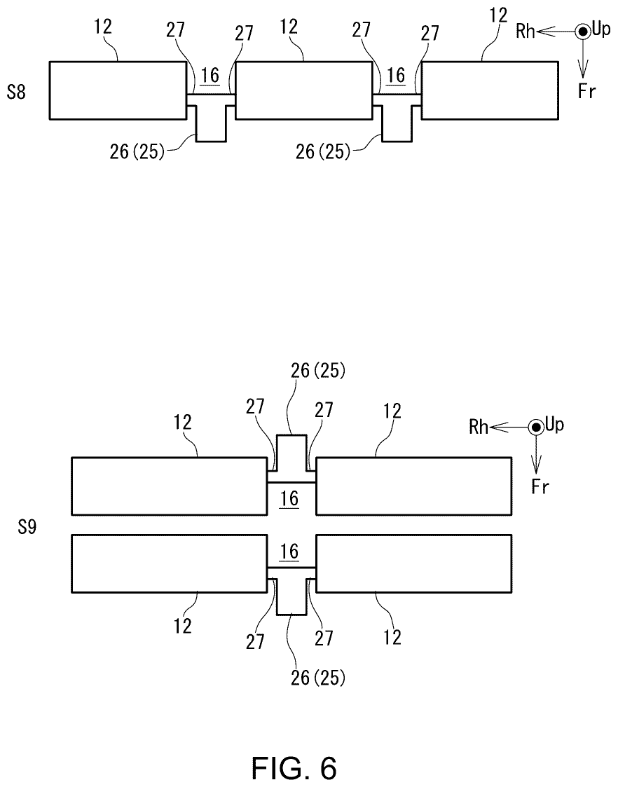

In the above description, the battery pack 10 includes the two cell modules 12. However, the number of the cell modules 12 is not particularly limited as long as it is two or more, and may be, for example, three. In this case, as shown in the upper part (state S8) of FIG. 6, the battery pack 10 may have two intermediate spaces 16. A part of the duct 25 may be disposed in each of the two intermediate spaces 16.

As long as the battery pack 10 has a plurality of cell modules 12 adjacent to each other in the longitudinal direction, the battery pack may further have cell modules 12 adjacent to each other in the short direction. That is, as shown in the lower part (state S9) of FIG. 6, four or more cell modules 12 may be arranged in an array in the longitudinal direction and the short direction.

Further, in the above description, the battery pack 10 is disposed in a posture in which the longitudinal direction of the cell module 12 is substantially parallel to the vehicle width direction of the vehicle. However, the arrangement and orientation of the battery pack 10 in the vehicle may be changed as appropriate. For example, the battery pack 10 may be disposed such that the longitudinal direction of the cell module 12 is substantially parallel to the longitudinal direction of the vehicle.

### REFERENCE SIGNS LIST

10 battery pack, 12 cell module, 14 battery cell, 15 separator, 16 intermediate space, 18 battery controller, 20 connector, 22 wire harness, 24 fuse, 25 duct, 26 main duct, 27 sub duct, 30 junction box, 32 service plug, 100 rear seat.

1. A battery pack comprising:
a plurality of cell modules; and
at least one battery-related device,
wherein the plurality of cell modules are arranged side by side in a longitudinal direction thereof, with an intermediate space interposed therebetween, and
the at least one battery-related device is disposed inside the intermediate space or above the intermediate space.

2. The battery pack according to claim 1, wherein the at least one battery-related device includes:
an electronic device disposed above the intermediate space; and
a connector that is disposed below the electronic device and electrically relays the electronic device and a wire harness, and
a dimension of the intermediate space in the longitudinal direction is smaller than a dimension of the electronic device in the longitudinal direction.

3. The battery pack according to claim 1, wherein the at least one battery-related device includes:
a fuse disposed inside the intermediate space; and
a connector which is disposed inside the intermediate space or above the intermediate space and to which a wire harness extending from each of the plurality of cell modules is connected.

4. The battery pack according to claim 2, wherein
the connector is disposed in an orientation such that an insertion opening of the wire harness faces downward.

5. The battery pack of claim 1, wherein the at least one battery-related device includes a duct, a part of which is disposed inside the intermediate space.
